(19) United States
(12) Patent Application Publication
(10) Pub. No.: US 2015/0107051 A1
(43) Pub. Date: Apr. 23, 2015

(54) ROTATING SHAFT HOUSING STRUCTURE OF ROTATING MEMBER AND ELECTRONIC DEVICE

(71) Applicant: Casio Computer Co., Ltd, Tokyo (JP)

(72) Inventors: Otoya Sakai, Machida Tokyo (JP); Tetsuhiro Maruyama, Kokubunji Tokyo (JP)

(21) Appl. No.: 14/512,112

(22) Filed: Oct. 10, 2014

(30) Foreign Application Priority Data
Oct. 18, 2013 (JP) 2013-217292

(51) Int. Cl. H04N 5/225; H04N 5/232; F16C 11/04

(52) U.S. Cl. CPC H04N 5/2252; F16C 11/04; H04N 5/23293
USPC 16/223; 16/221

(57) ABSTRACT

A rotating shaft housing structure of rotating members, including: a main body; rotating shafts for the rotating members; and a common recess which is provided in the main body, wherein the rotating members are attached to the main body via the respective rotating shafts so as to be rotatable, and the rotating shafts are housed alongside each other in the common recess.

### CROSS-REFERENCE TO RELATED APPLICATION

The entire disclosure of Japanese Patent Application No. 2013-217292 filed on Oct. 18, 2013 including description, claims, drawings, and abstract are incorporated herein by reference in its entirety.

### BACKGROUND OF THE INVENTION

1. Field of the Invention

The present invention relates to a rotating shaft housing structure of a plurality of rotating members such as a liquid crystal monitor and a stand, and an electronic device which includes the plurality of rotating members having the rotating shaft housing structure.

2. Description of Related Art

There are cameras which include liquid crystal monitors provided on main bodies via hinge units so as to be rotatable (for example, see Japanese Patent Application Laid Open Publication No. 2012-80400).

There are also cameras which include stands provided on back surfaces of main bodies so as to adjust directions (angles) of optical axes (for example, see Japanese Patent Application Laid Open Publication No. 2003-5266).

FIGS. 10 to 12 show an example of a conventional camera which includes a liquid crystal monitor and a stand. In the drawings, the reference numerals 1 to 4 indicate a main body, a hinge unit, a liquid crystal monitor and a stand, respectively.

The hinge unit 2 is configured by incorporating the nearly parallelogram link mechanism disclosed in Utility Model Registration No. 3179328 into a case.

As shown in FIGS. 10 and 12, the stand 4 of the camera can hold the main body 1 by being rotated around stand shafts 4a with respect to the main body 1 and opened at a desired angle.

Self-photography can be performed by pulling out the hinge unit 2 from the main body 1 by the nearly parallelogram link mechanism and rotating the liquid crystal monitor 3 around hinge shafts 2a for 180 degrees to be reversed, which is a tilt-up state.

In addition, as shown in FIG. 12, the main body 1 can be vertically placed being supported by a lateral surface of the stand 4.

After photography, the liquid crystal monitor 3 is rotated backward via the hinge unit 2 to be housed on the back surface of the main body 1.

The stand 4 is rotated via the stand shafts 4a to be housed inside the hinge unit 2 and the liquid crystal monitor 3.

### SUMMARY OF THE INVENTION

According to one aspect of the present invention, there is provided a rotating shaft housing structure of rotating members, including: a main body; rotating shafts for the rotating members; and a common recess which is provided in the main body, wherein the rotating members are attached to the main body via the respective rotating shafts so as to be rotatable, and the rotating shafts are housed alongside each other in the common recess.

According to another aspect of the present invention, there is provided an electronic device, including a plurality of rotating members having the rotating shaft housing structure.

### BRIEF DESCRIPTION OF THE DRAWINGS

The above and other objects, advantages and features of the present invention will become more fully understood from the detailed description given hereinafter and the appended drawings which are given byway of illustration only, and thus are not intended as a definition of the limits of the present invention, and wherein:

FIG. 1 shows a configuration of an electronic device in an embodiment to which the present invention is applied, and is a perspective view of a camera seen from the lateral side;

FIG. 2 is a perspective view of the camera in FIG. 1 seen from the back side;

FIG. 3 is a longitudinal sectional side view of the camera in FIG. 1;

FIG. 4 is a view showing a state in which the stand in FIG. 2 is housed in a main body;

FIG. 5 is a schematic longitudinal sectional view showing a state in which a hinge plate, a liquid crystal monitor and a stand are housed in the main body;

FIG. 6 is a perspective view showing a state in which the camera in FIG. 2 is placed vertically with the stand;

FIG. 7 is a lateral view schematically showing a state in which the angle between the main body and the stand in FIG. 1 is smallest;

FIG. 8 is a lateral view schematically showing a state in which the angle between the main body and the stand in FIG. 1 is largest on practical use;

FIG. 9 is a back view showing a state in which the stand in FIG. 1 is used; and

FIG. 10 is a perspective view of an example of a conventional camera provided with a liquid crystal monitor and a stand, showing a state in which the liquid crystal monitor is tilted up and the stand is used;

FIG. 11 is a back view of the camera in FIG. 10; and

FIG. 12 is a lateral view showing a state in which the camera in FIG. 10 is vertically placed with the stand.

### DETAILED DESCRIPTION OF THE PREFERRED EMBODIMENT

Hereinafter, an embodiment for performing the present invention will be described in detail with reference to the drawings.

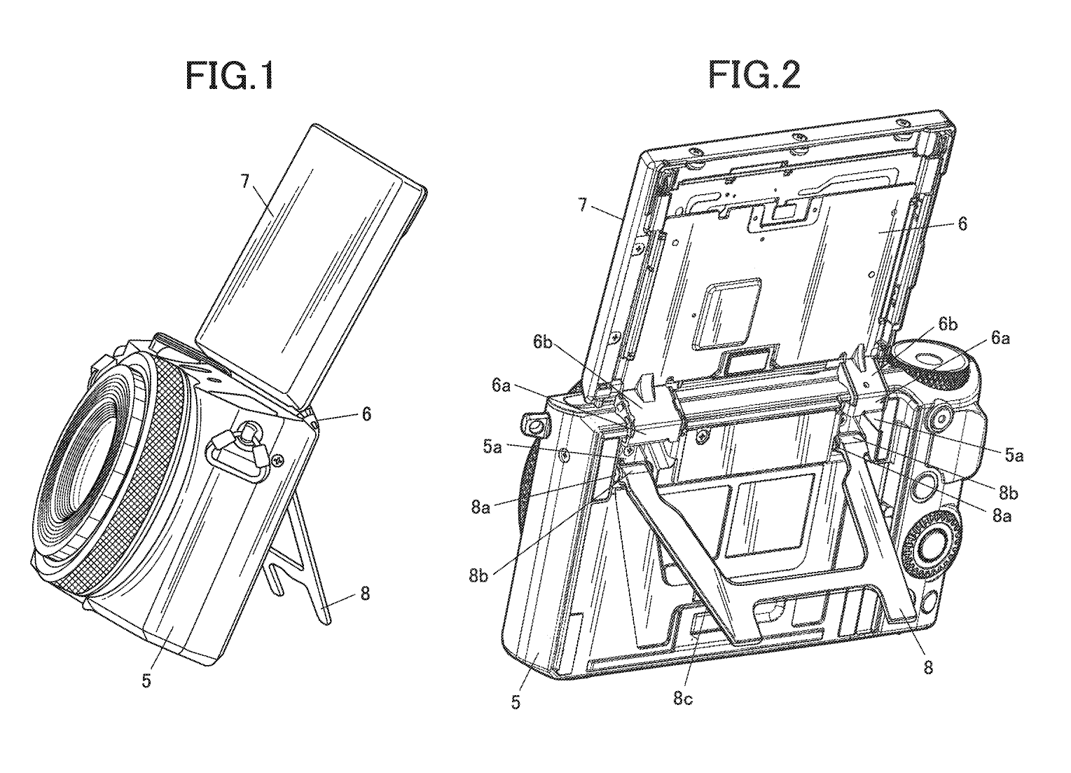

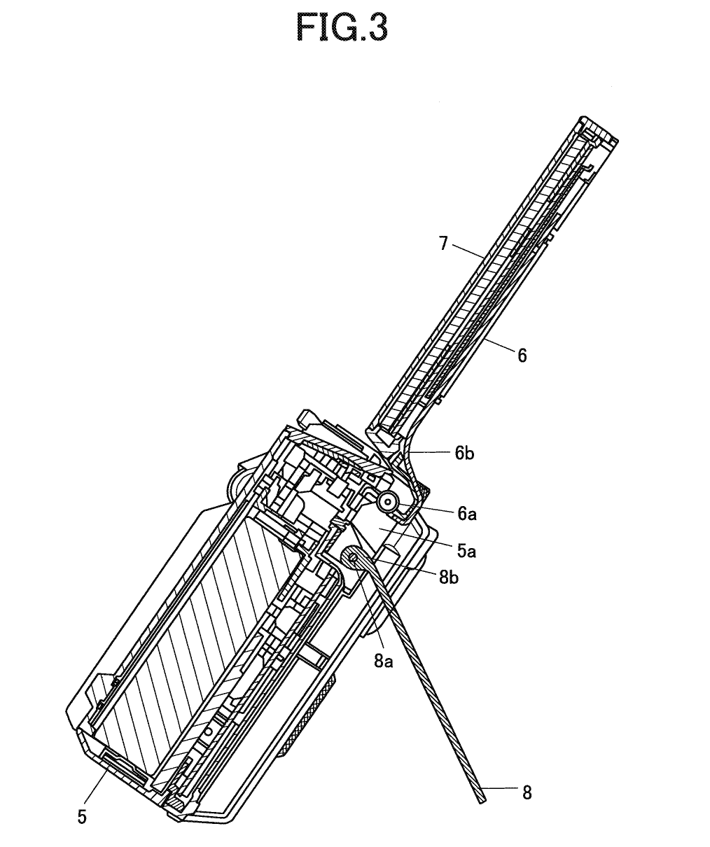

FIGS. 1 to 3 show a camera as a configuration of an electronic device in an embodiment to which the present invention is applied.

As shown in the drawings, a liquid crystal monitor 7 is rotated around rotating shafts 6a of a hinge plate 6 from the back surface of the main body 5 and opened approximately 180 degrees to stand vertically on the main body 5.

That is, the hinge plate 6 is united to the back surface of the liquid crystal monitor 7 and a pair of left and right rotating shafts 6a made of sheet metal is integrally formed at the lower section of the hinge plate 6.

As shown in the drawings, the sheet metal rotating shafts 6a are supported so as to be rotatable in common recesses 5a which are formed at left and right sides of the back surface upper section of the main body 5. Thus, the liquid crystal monitor 7 is rotated around the rotating shafts 6a.

In the illustrated example, as for each of the sheet metal rotating shafts 6a, a part of the rotating shaft 6a is protruding backward with respect to the main body 5 to eliminate necessity of a cut-out portion for clearance on the upper surface of the main body 5 and make the liquid crystal monitor 7 stand up vertically. The width of the sheet metal rotating shaft 6a is large so as to ensure the necessary strength.

As shown in the drawings, the sheet metal parts including the respective rotating shafts 6a of the hinge plate 6 are curved units 6b which are curved from the back surface of the main body 5 to the liquid crystal monitor 7. In other words, the curved units 6b are curved from the back surface of the main body 5 to the respective common recesses 5a when the liquid crystal monitor 7 is housed in the main body 5 as described later.

The stand 8 is attached to the back surface upper section of the main body 5 so as to be rotatable around a pair of left and right rotating shafts 8a.

As shown in the drawings, the rotating shafts 8a are arranged immediately below the respective rotating shafts 6a so as to be close to the respective rotating shafts 6a and supported so as to be rotatable in the common recesses 5a at the left and right sides of the back surface upper section of the main body 5, respectively. Thus, the stand 8 is rotated around the rotating shafts 8a.

That is, as shown in the drawings, the stand 8 is opened at a desired angle around the rotating shafts 8a at the back surface upper section of the main body 5 to hold the main body 5 at the back surface upper section.

Though not shown in the drawings, each of the rotating shafts 8a has a plate spring to apply a brake so that the stand 8 can be held at any angle.

As shown in the drawings, the end portions of the stand 8 near the rotating shafts 8a are curved units 8b curved from the back surface of the main body 5 to the respective common recesses 5a.

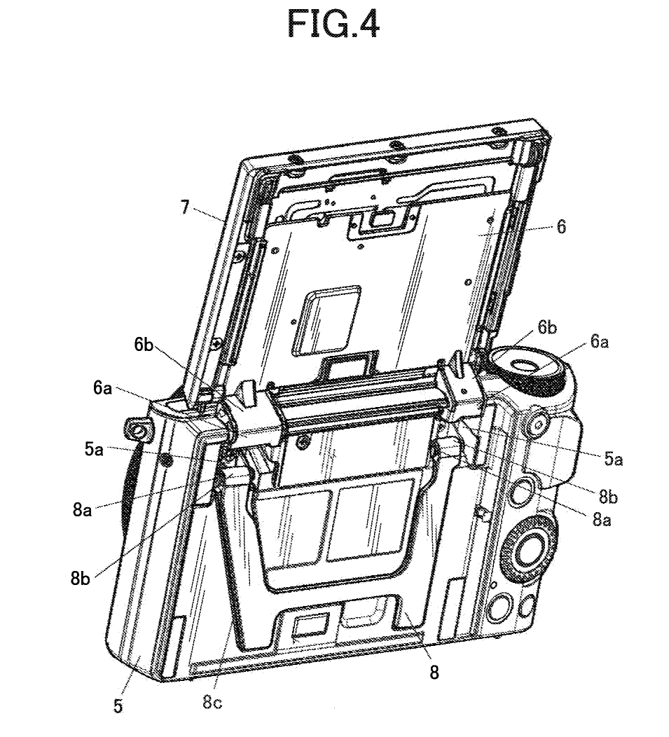

FIG. 4 shows a state in which the stand 8 is housed on the back surface of the main body 5.

As shown in the drawing, the left end portion of the stand 8 is an inclined portion 8c formed so that the stand 8 has a narrow end at the opposite side to the rotating shafts 8a and has a laterally unsymmetrical shape.

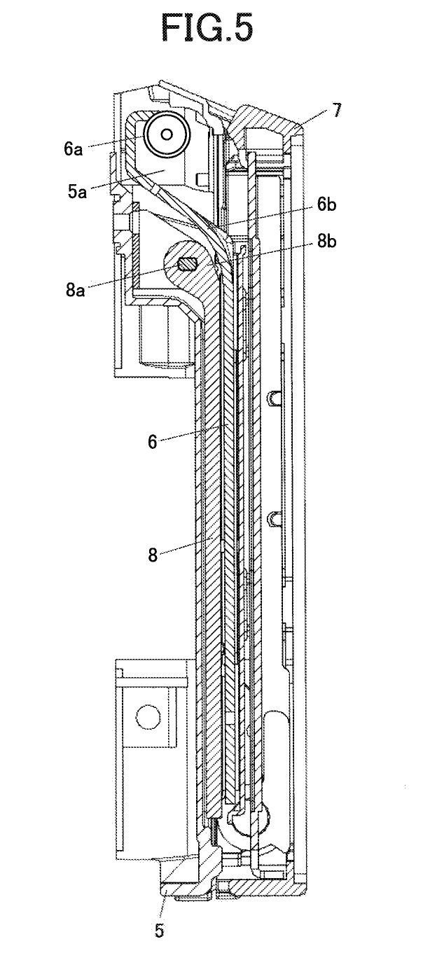

FIG. 5 shows a longitudinal sectional view in which the hinge plate 6, the liquid crystal monitor 7 and the stand 8 are housed on the back surface of the main body 5.

As shown in the drawing, the curved units 6b which are sheet metal parts including the rotating shafts 6a of the hinge plate 6 and the curved units 8b which are lateral ends of the rotating shafts 8a of the stand 8 are housed so as to overlap each other in a nearly parallel manner.

Accordingly, the hinge plate 6, the liquid crystal monitor 7 and the stand 8 can be compactly housed on the back surface of the main body 5.

As shown in FIGS. 1 to 3, the above-mentioned camera enables self-photography by the liquid crystal monitor 7 being rotated around the rotating shafts 6a for 180 degrees to be reversed and thereby vertically standing on the main body 5, which is a tilt-up state.

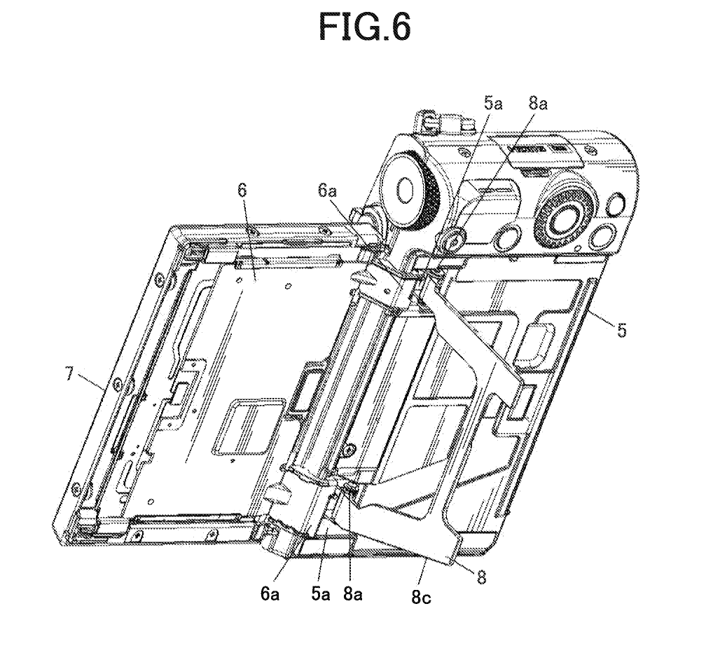

Furthermore, as shown in FIG. 6, the main body 5 can be vertically placed by being supported with a lateral surface of the stand 8.

When the main body 5 is vertically placed in such way, the main body 5 can be stably held in an inclined state since the lower lateral portion of the stand 8 is the inclined portion 8c.

Since the pair of rotating shafts 8a of the stand 8 is arranged at the laterally same position as the pair of rotating shafts 6a of the hinge plate 6, the stand 8 can have a large width which is the same width as the hinge plate 6, and thus, the main body 5 is supported by the stand 8 with high stability.

That is, the stand 8 holds the main body 5 at the regions contacting the main body 5 for a wide range, leading to high stability.

Since the rotating shafts 8a of the stand 8 are effectively located in a space below the rotating shafts 6a of the hinge plate 6, the length of the stand 8 can be secured.

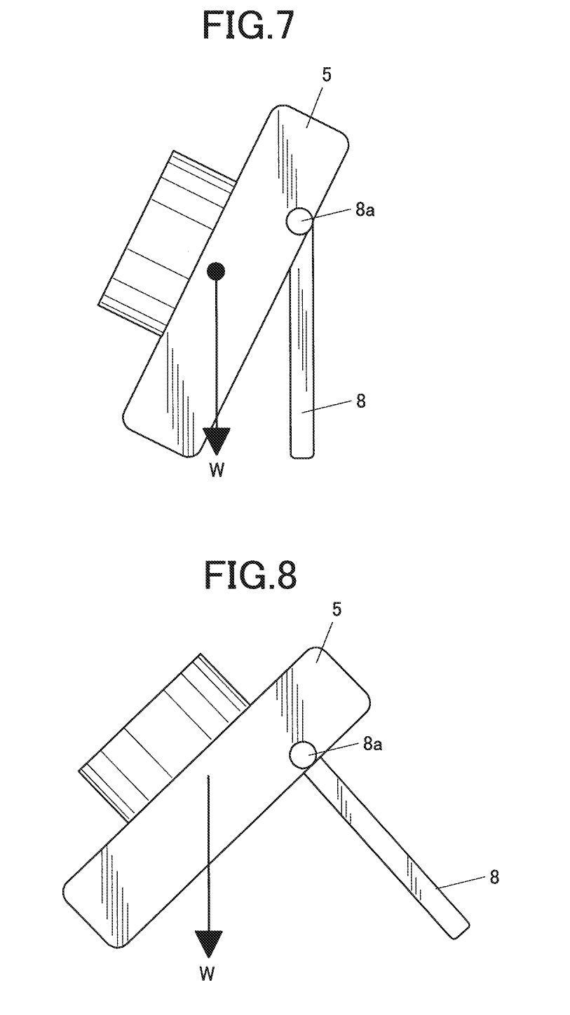

Next, FIGS. 7 to 9 are schematic views, and FIG. 7 shows a state in which the angle between the stand 8 and the main body 5 is smallest.

As shown in the drawing, the load W from the center of gravity of the main body 5 is far away from the stand 8, and the center of gravity of main body 5 is located at a position lower than the rotating shafts 8a of the stand 8, leading to sufficient stability.

FIG. 8 shows a state in which the angle between the stand 8 and the main body 5 is the largest angle on practical use.

As shown in the drawing, the load W from the center of gravity of the main body 5 has a sufficient distance from the stand 8, leading to stability.

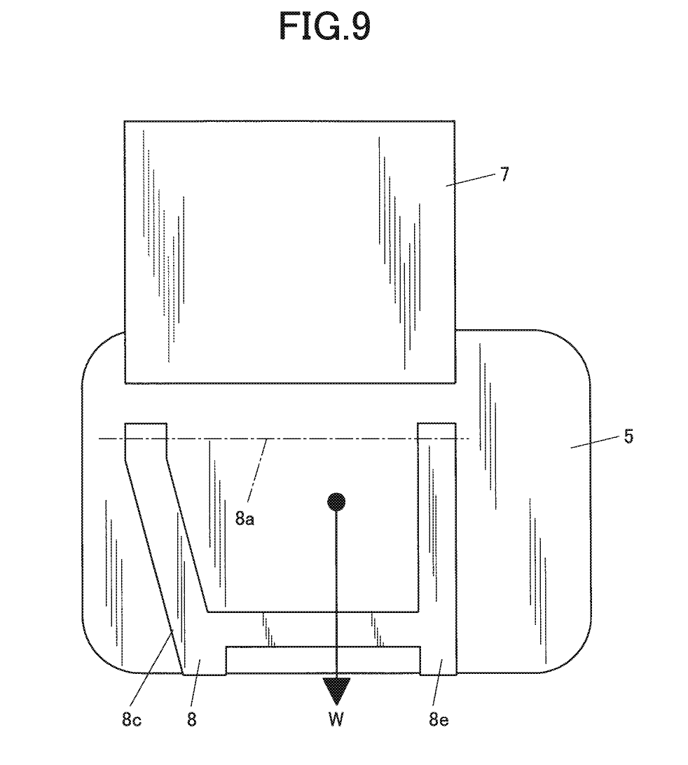

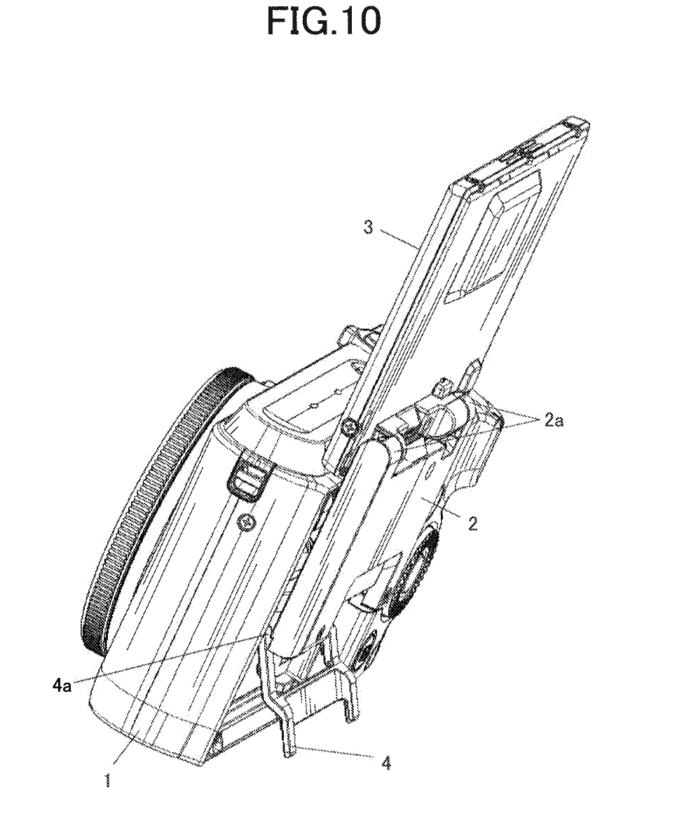

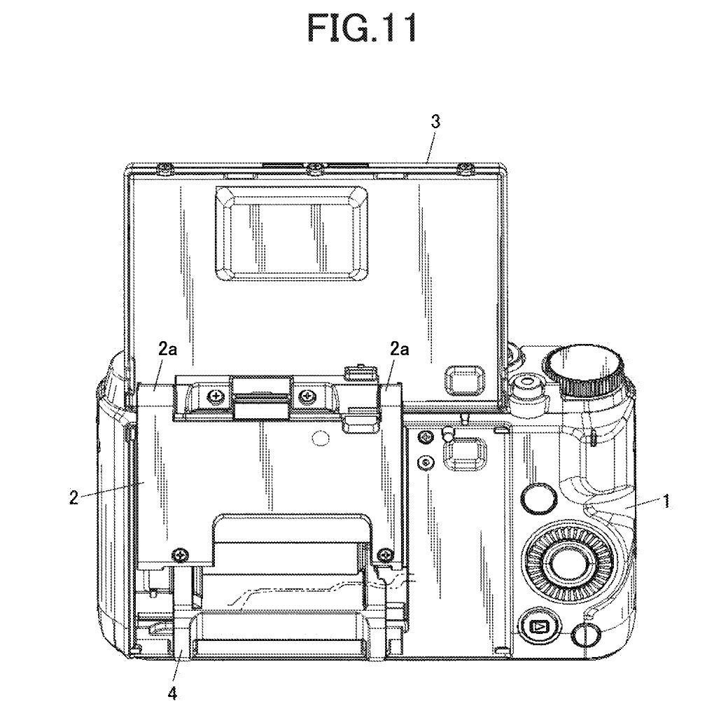

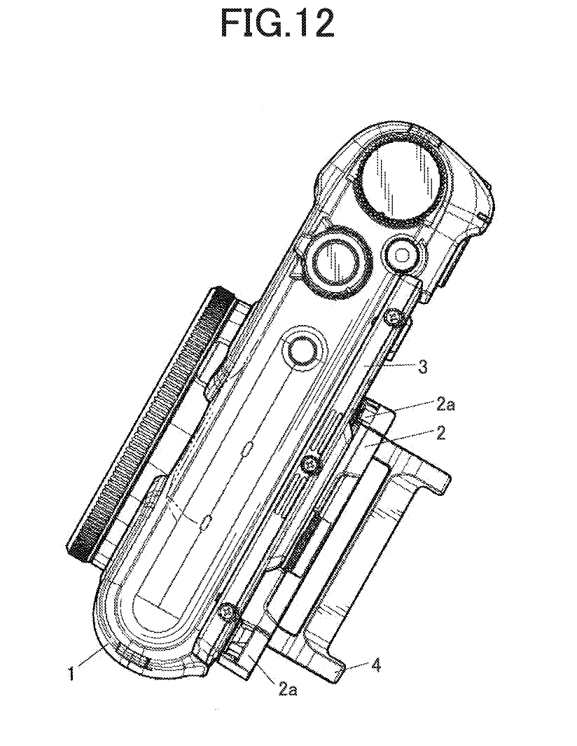

FIG. 9 shows, from the back side of the camera, a state in which the stand 8 is used.

As shown in the drawing, the load W from the center of gravity of the main body 5 has a distance from the right end 8e of the stand 8, and the center of gravity of the main body is located at a position lower than the rotating shafts 8a of the stand 8, leading to good stability.

As described above, a pair of left and right rotating shafts 6a of the liquid crystal monitor 7 is respectively arranged in a pair of left and right common recesses 5a formed at the back surface upper section of the main body 5, and further, the left and right rotating shafts 8a of the stand 8 are effectively arranged in spaces below the rotating shafts 6a. Thus, the length of stand 8 can be secured and the main body 5 can be held for a wide range by the stand 8.

That is, since the distance between the rotating shafts 8a of the stand 8 can be increased according to the width of hinge plate 6, the stability of the stand 8 when used can be enhanced.

Accordingly, it is possible to provide the stand 8 which holds the main body 5 for a wide range with good stability.

The liquid crystal monitor 7 and the stand 8 can be largely rotated without interfering with each other when they are to be housed on the back surface of the main body 5 and when they are to be projected from the back surface of the main body 5.

As described above, according to the rotating shaft housing structure of two rotating members in the embodiment, since the rotating shafts 6a of the liquid crystal monitor 7 and the rotating shafts 8a of the stand 8 are housed at upper and lower positions respectively in the common recesses 5a provided at the back surface upper section of the main body 5, it is possible to rotate the liquid crystal monitor 7 and the stand 8 without interfering with each other both when housing them and projecting them while improving the outer appearance by housing them when they are not used.

Furthermore, since the main body 5 only needs to have common recesses 5a for housing the rotating shafts 6a and 8a, the cost can be suppressed and reduction in internal volume of the main body 5 can also be suppressed.

### Modification Example

Though the present invention is applied to a liquid crystal monitor and a stand of a camera in the above embodiment, the present invention is not limited to this and may be applied to at least two other rotating members such as another display unit and a cover or a handle of various devices.

Furthermore, the present invention is not limited to a camera, and may be applied to other electronic devices such as a mobile phone including a camera and a pachinko machine in which a front door frame is attached, via rotating shafts, to a main body frame that is attached to an outer frame via rotating shafts.

It goes without saying that the shapes and such like of the rotating members are arbitrary and the other specific detailed configurations and such like may also be appropriately changed.

Though several embodiments of the present invention have been described above, the scope of the present invention is not limited to the above embodiments, and includes the scope of inventions, which is described in the scope of claims, and the scope equivalent thereof.

What is claimed is:

1. A rotating shaft housing structure of rotating members, comprising:
a main body;
rotating shafts for the rotating members; and
a common recess which is provided in the main body,
wherein
the rotating members are attached to the main body via the respective rotating shafts so as to be rotatable, and
the rotating shafts are housed alongside each other in the common recess.

2. The rotating shaft housing structure of the rotating members according to claim 1, wherein
the common recess is provided at an end portion of the main body, and
the rotating members are independent members which are functionally different from each other.

3. The rotating shaft housing structure of the rotating members according to claim 1,
wherein
the rotating members include:
a display unit which is attached, via a rotating shaft, to the common recess formed at an upper section of a back surface of the main body and is operable to tilt up on the main body; and
a stand which is attached to the common recess via a rotating shaft and supports the main body.

4. The rotating shaft housing structure of the rotating members according to claim. 1, wherein the rotating members have curved shapes which are nearly parallel to each other, the curved shapes being curved along the common recess formed at an upper section of a back surface of the main body to the back surface of the main body.

5. The rotating shaft housing structure of the rotating members according to claim 1, wherein the rotating members are largely rotated without interfering with each other both when they are to be housed on a back surface of the main body and when they are to be projected from the back surface of the main body.

6. The rotating shaft housing structure of the rotating members according to claim 3, wherein the stand is formed to be laterally unsymmetrical with a lateral end inclined.

7. An electronic device, comprising a plurality of rotating members having the rotating shaft housing structure according to claim 1.
